(19) United States
(12) Patent Application Publication
(10) Pub. No.: US 2021/0091426 A1
(43) Pub. Date: Mar. 25, 2021

(54) LITHIUM-ION BATTERY RECYCLING PROCESSES AND SYSTEMS

(71) Applicant: VIRGINIA TECH INTELLECTUAL PROPERTIES INC., BLACKSBURG, VA (US)

(72) Inventors: Zheng Li, Blacksburg, VA (US); Tairan Yang, Blacksburg, VA (US); Michael W. Ellis, Blacksburg, VA (US)

(21) Appl. No.: 16/603,521

(22) PCT Filed: Apr. 6, 2018
(86) PCT No.: PCT/US2018/026528

§ 371 Date: Oct. 7, 2019

Related U.S. Application Data
(60) Provisional application No. 62/482,247, filed on Apr. 6, 2017.

(51) Int. Cl. H01M 10/54; H01M 4/525; H01M 4/58; H01M 4/505; H01M 10/0525; C01B 25/45; C01G 51/00; C01G 45/12

(52) U.S. Cl. CPC H01M 10/54; H01M 4/525; H01M 4/5825; H01M 4/505; H01M 2004/028; C01B 25/45; C01G 51/50; C01G 45/1242; C01G 51/42; H01M 10/0525

(57) ABSTRACT

Re-lithiation methods and systems are disclosed. Example re-lithiation methods include separating lithium depleted active cathode material from a cathode and introducing lithium containing materials. Also disclosed are re-lithiation electrochemical flow systems utilizing voltage potential to re-lithiate a lithium depleted active cathode material from a reservoir of lithium containing material.

### CROSS-REFERENCE TO RELATED APPLICATIONS

The attached provisional application claims priority from U.S. Provisional Application Ser. No. 62/482,247, filed Apr. 6, 2017, the contents of which are incorporated by reference herein in its entirety.

### BACKGROUND OF THE INVENTION

Lithium-ion battery technology is considered as the best near-term energy storage technology due to its high power and energy density, long cycle life, high potential and low self-discharge rate. It is widely used in consumer electronics, electric vehicles and grid energy storage. Although the battery market is currently dominated by consumer electronic batteries, the market share of electric vehicle batteries will continue to increase because the electrification of transportation is a continual effort on the road towards energy independence and infrastructure resilience.

Issues related to lithium-ion batteries such as battery material supply, environmental problems during production process or end of life, and manufacturing cost will continue to raise more concerns in conjunction with the increase of lithium-ion battery market share in the near future. Recycling of lithium-ion batteries provides a means to lower the total lifetime energy consumption, battery material demand, and decreases the manufacturing cost. Further, according to a current aggressive prediction of lithium-ion battery market penetration, the world's cobalt demand from cobalt related battery cathodes, which are often used in lithium-ion batteries, could end up accounting for 10% of the world's cobalt reserve by the year 2050.

In addition, the battery production process itself, each battery constituent contributes to energy consumption and greenhouse gas (GHG) emission. For example, wrought aluminum takes up around half of the cradle-to-gate energy consumption or GHG emission. Aluminum is followed by cathode materials which contributes between 10%-14% of energy consumption of GHG emission. It follows that recycling aluminum and cathode material can significantly cut down the energy consumption and GHG emission of battery production. In terms of impact of the battery in a whole electric vehicle (EV) life cycle (well-to-pump, pump-to-wheels and vehicle cycle), it is rather different for life-cycle energy use, C0₂ emission and sulfur oxide (SOx) emission. Batteries make small contributions to life-cycle energy use and C0₂ emissions but make significant contributions to SOx emissions, especially when the cathode material contains Co or Ni. A recycling process delivers more benefits if the cathode material, or maybe anode material, is recovered because cathode material is considered as the most valuable part in a battery.

Battery recycling process falls into three broad categories: smelting, hydrometallurgical, and, as disclosed in the current invention, direct recycling. The first two methods are also regarded as indirect recycling because structural materials are not recovered, only raw materials. Smelting battery recycling will smelt end-of-life battery directly and recover some of the useful metals. This avoids some of the ore processes in battery production and is available commercially now. During smelting process, high temperature is required and organics are burned as reductants. Valuable metals such as Co, Ni and Cu are recovered in the form of an alloy from the bottom of smelters, thus leaching is required to separate the recovered metals. Smelting is flexible for both input and output. Batteries with different types of cathode materials (e.g. LiCoO₂, LiMn₂O₄, LiNiₓMn_{y}Co₂O₂ x+y+z=1) can economically be recycled by smelting. However, LiFePO₄ (LFP) cathodes, while technically capable of being recycled by smelting, are generally not because metals being recovered from LFP batteries are less valuable compared to other cathodes and thus, are not worth using smelt recycling under current economic conditions. The recovered metals can be used for any new battery manufacturing.

One disadvantage of the smelting process is that lithium and aluminum goes to slag in the end of smelting and thus requires extensive and costly processing prior to being used again. In addition, the smelting process itself requires large volumes of used batteries and involves extensive waste gas treatment.

Hydrometallurgical recycling processes will separate/isolate battery constituents first before processing. This recycling process is also applicable to Ni-MH batteries. For lithium-ion batteries, lithium is ultimately recovered as Li₂CO₃ and other major materials such as Co, Ni, Al can also be recovered. For Ni-MH batteries, rare earths and nickel can be recovered. Although hydrometallurgical recycling processes do not require high temperature and high volume, the processes ultimately changes the morphology of battery cathode materials rendering them unsuitable for re-use without further processing. .

One example process that attempted to improve the cathode recycling efficiency is U.S. Pat. No. 8,846,225 to Sloop (“Sloop”), which is herein incorporated by reference in its entirety. Sloop describes a high temperature sintering process that is purported to add lithium to a lithium depleted electrode. However, such high temperature process can cause decomposition and evaporation of organic deposits on or within the cathode, which can impede crack healing. Further the high temperature process causes changes in Li particle morphology resulting in smaller crystal size, which ultimately results in a less efficient electrode.

Improved recycling processes and systems are desired that maintain electrode morphology and efficiency and also decreases the overall cost and energy usage of recycling lithium based battery electrodes.

### BRIEF SUMMARY OF THE INVENTION

Disclosed herein are methods and systems for re-lithiated a lithium depleted battery cathode active material. In one aspect, a method of re-lithiated a lithium depleted battery cathode active material includes adding lithium containing material to the depleted cathode active material to form a combination. In another aspect, a method of re-lithiated a lithium depleted battery cathode active material includes heating the combination to greater than or equal to about 100 degrees Celsius and to less than a sintering temperature of the combination for a time period of greater than or equal to one hour. In yet another aspect, a method of re-lithiated a lithium depleted battery cathode active material includes a depleted cathode active material being at least one of lithium depleted LiCoO₂, lithium depleted LiNiₓMn_{y}CozO₂ (x+y+z=1), lithium depleted LiMn_{y}O₄, and lithium depleted LiFePO₄. And in yet another aspect, a method of re-lithiated a lithium depleted battery cathode active material includes a combination heated to no more than about 500 degrees Celsius.

Disclosed herein are methods for re-lithiated a lithium depleted battery cathode active material. In one aspect, a method of re-lithiated a lithium depleted battery cathode active material includes separating depleted cathode active material from a cathode. In one aspect, a method of re-lithiated a lithium depleted battery cathode active material includes suspending a lithium depleted cathode active material in the solvent. In another aspect, separating the lithium depleted cathode active material from the cathode includes separating the lithium depleted cathode active material from the solvent by a filter and/or a centrifuge. And in yet another aspect, separating the lithium depleted cathode active material from the cathode includes at least one of drying and grinding the lithium depleted cathode active material prior to adding the adding lithium containing material. And in a different aspect, separating the lithium depleted cathode active material from the cathode includes rinsing the cathode in dimethyl carbonate. In yet another aspect, adding lithium containing material to the lithium depleted cathode active material includes adding the lithium depleted cathode active material to a suspension containing at least one lithium salt, wherein the lithium depleted cathode active material and the suspension are within a cathode chamber.

Disclosed herein are methods for re-lithiated a lithium depleted battery cathode active material. In one aspect, a method of re-lithiated a lithium depleted battery cathode active material includes using a cathode chamber and a galvanic separator, where the cathode chamber is adjacent an anode chamber containing an anode chamber lithium salt containing solution, where the galvanic separator is between the cathode chamber and the anode chamber, and where the galvanic separator is adapted to pass lithium ions. In another aspect, adding lithium containing material to a lithium depleted cathode further includes supplying a constant current voltage potential to a working electrode electrically connected to the lithium depleted cathode active material and to a counter electrode electrically connected to the anode chamber lithium salt containing solution. In yet another aspect, adding lithium containing material to the lithium depleted cathode includes supplying a constant current voltage potential to a working electrode electrically connected to a lithium depleted cathode active material and to a counter electrode electrically connected to an anode chamber lithium salt containing solution. In yet another aspect, a method of re-lithiated a lithium depleted battery cathode active material includes using a working electrode and the working electrode has a positive voltage potential as compared to a counter electrode. In yet another aspect, a counter electrode and a lithium salt containing solution undergo an oxygen evolution reaction.

Disclosed herein are methods for re-lithiated a lithium depleted battery cathode active material. In one aspect, a method of re-lithiated a lithium depleted battery cathode active material includes stopping a constant current voltage potential when a working electrode potential versus a reference electrode potential reaches between about −0.8V to about −1.0 V, inclusive. In another aspect, a heating a combination step takes place after a supplying a constant current voltage potential step. In yet another aspect an anode chamber is hydraulically connected to a lithium reservoir via a feed pipe. In another aspect, a lithium reservoir has a greater volume than an anode chamber. In yet another aspect, a lithium reservoir contains at least one of lithium containing seawater, brine water, wastewater, and lithium containing ores. And in yet another aspect, a lithium reservoir has a total charge storage capacity that is at least five times larger than a charge storage capacity of an anode chamber. And in another aspect separating a depleted cathode active material from a cathode includes at least one of drying and grinding a depleted cathode active material prior to adding a lithium containing material. In another aspect, a heating step makes a re-lithiated cathode active material and the re-lithiated cathode active material comprises an x-ray diffraction peak at about 38 degrees.

Disclosed herein are re-lithiation electrochemical flow systems. In one aspect the flow system includes a cathode chamber containing a cathode electrode and a suspension containing at least one lithium salt and a lithium depleted cathode active material. In another aspect a re-lithiation electrochemical flow system includes an anode chamber containing an anode electrode and an anode chamber lithium salt containing solution. In another aspect, a re-lithiation electrochemical flow system includes a galvanic separator between a cathode chamber and an anode chamber, wherein the galvanic separator is adapted to pass lithium ions. And in yet another aspect, a re-lithiation electrochemical flow system includes a lithium reservoir having a total charge storage capacity that is at least five times larger than a charge storage capacity of an anode chamber lithium salt containing solution within an anode chamber.

### BRIEF DESCRIPTION OF THE DRAWINGS

FIG. 1 is a drawing of an example separating process in accordance with disclosed embodiments;

FIG. 2 shows a photograph of example dried depleted lithium cathode material in accordance with disclosed embodiments;

FIG. 3 shows a photograph of an example grinding method in accordance with disclosed embodiments;

FIG. 4 is a drawing of an example combining process in accordance with disclosed embodiments;

FIG. 5 is a picture showing an example pellet formed in accordance with disclosed embodiments

FIG. 6 is a drawing of an example heating process in accordance with disclosed embodiments;

FIG. 7 is a chart of x-ray diffractions of commercial, cycled (depleted), and re-lithiated active cathode material in accordance with disclosed embodiments;

FIG. 8 shows scanning electron microscope views in accordance with disclosed embodiments;

FIG. 9 shows scanning electron microscope views in accordance with disclosed embodiments;

FIGS. 10a and 10b show electrochemical performance graphs of an example Li-ion cells made in accordance with disclosed embodiments;

FIGS. 11a and 11b show electrochemical performance graphs of an example Li-ion cells made in accordance with disclosed embodiments;

FIGS. 12a and 12b show electrochemical performance graphs of an example Li-ion cells made in accordance with disclosed embodiments;

FIGS. 13a and 13b show electrochemical performance graphs of an example Li-ion cells made in accordance with disclosed embodiments;

FIG. 14 is a drawing of an example electro chemical process in accordance with disclosed embodiments;

FIG. 15 is a drawing of a detail view of FIG. 14, a schematic view of a re-lithiation electrochemical flow system in accordance with disclosed embodiments;

FIG. 16 shows a photograph of an example re-lithiation electrochemical flow system in accordance with disclosed embodiments;

FIG. 17 is a graph of an example voltage plot of electrochemical electrodes in accordance with disclosed embodiments;

FIG. 18 shows x-ray diffractions of commercial and re-lithiated active cathode material in accordance with disclosed embodiments;

FIG. 19 shows scanning electron microscope views in accordance with disclosed embodiments;

FIG. 20 shows scanning electron microscope views in accordance with disclosed embodiments;

FIGS. 21a and 21b show electrochemical performance graphs of an example Li-ion cells made in accordance with disclosed embodiments;

FIGS. 22a and 22b show electrochemical performance graphs of an example Li-ion cells made in accordance with disclosed embodiments; and

FIGS. 23a and 23b show electrochemical performance graphs of an example Li-ion cells made in accordance with disclosed embodiments.

### DETAILED DESCRIPTION OF THE INVENTION

Disclosed recycling processes and systems, also referred to herein as direct recycling, yields battery-grade materials which are high value materials as compared to the remaining battery material. The electrolyte is also recoverable. The disclosed recycling processes and systems are low-temperature processes and do not require large volumes of material. Most importantly, the structure, morphology, and electrochemical properties of valuable material, particularly the cathode material, is retained.

As noted above, recycling provides energy savings, reduces battery production cost and reduces gas emissions. Battery cost is dominated by material cost (roughly one half or more) and the material cost is dominated by the cathode cost. Battery cathode materials are 2-4 times as valuable as the other constituent elements. This indicates that while recycling of cathode material provide cost savings, recycling of structural materials, i.e., restoring battery components (direct recycling), rather than recycling each component to elementary materials, will increase the savings.

As will be discussed further below, disclosed lithium-ion battery recycling processes and associated systems can recycle all the valuable materials from a used lithium-ion battery, including but not limited to packaging material, aluminum and copper current collector, electrolyte, binder, cathode materials (including, but not limited to, LiCoO₂, LiNiₓMn_{y}CozO₂ x+y+z=1, LiMn_{y}O₄, LiFePO₄) and anode materials (graphite, silicon). The recycled electrode materials that are directly recovered from the used battery retains the same morphology, particle size distribution and electrochemical performance after processing. This process has the flexibility to recycle lithium-ion batteries from all types of manufacturing paradigm. Particular advantages are obtained for lithium-ion batteries having an aqueous soluble binder or binder-free electrode designs and cobalt (Co)-rich electrodes due to the particular solvents. However, alternative configurations are also available. For example, if the cathode materials use an aqueous binder (e.g., carboxymethyl cellulose), which dissolves in water instead of organic solvent like NMP, then NMP is not used to dissolve the binder in order to extract the LiₓCoO₂. Instead, as an alternative, the binder+carbon+LiₓCoO₂. can be directly suspended in an aqueous lithium containing solution to perform the re-lithiation.

Because Co-rich electrode materials have higher raw materials cost and higher volumetric energy density than Ni-rich electrode materials, there is more economic benefit to directly recovering those Co-rich electrodes with the same morphology and particle size distribution as the original electrode materials. For that reason, the remainder of the specification will discuss particular examples recycling lithium-ion batteries having a Co-rich electrode (LiCoO₂), however, direct recycling, and the accompanying processes discussed herein, is equally applicable to Ni-rich and other lithium based electrodes, including, but not limited to LiNiₓMn_{y}CozO₂ x+y+z=1, LiMn_{y}O₄, LiFePO₄. In addition, while the following discussion will refer to a single battery, the processes discussed is equally applicable to processing a plurality of batteries and battery components at the same time.

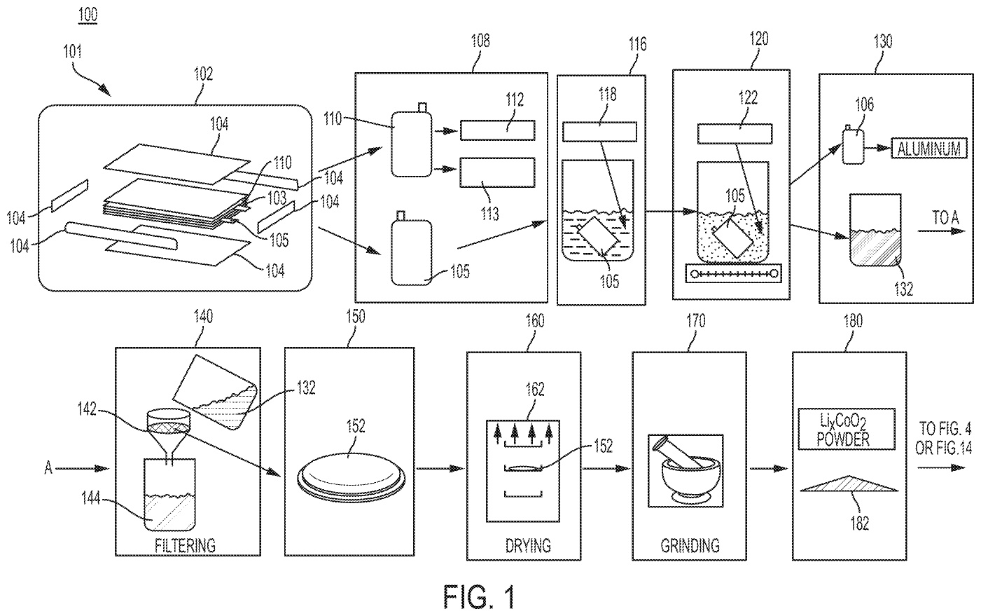

FIGS. 1-3 shows an example battery component extraction process 100. The battery 101 includes a protective cover 104 also referred to as a cell pouch or shell, an anode 110, a cathode 105, a separator 103 between the anode 110 and cathode 105 and an electrolyte 107. The electrolyte 107, in one example is a lithium based salt in an organic solvent. The anode 110 and cathode 105 are collectively referred to battery electrodes. Any such lithium-ion battery components known in the art may be used. At step 102, a cycled battery 101 is first disassembled. The protective cover 104 is cut, or otherwise opened. The protective cover 104 is collected and the electrode assembly, which includes the anode 110, the cathode 105, the separator 103, and the electrolyte 107 is exposed. The environment to disassemble the battery, in one example, can be a dry room, or disassembly line protected by inert atmosphere, a vented hood, or a unit of disassembling line operated at low temperature to prevent safety issues. The electrolyte may be collected and re-used after purification.

At step 110 the anode 110 and cathode 105 are separated. The separator 103 is detached from the electrodes 110, 105. The separator is inspected to determine if it is reusable and undamaged separators will be collected for re-use. The anode 110 may, in one example, be further processed to extract trace elements such as copper 112 and residual lithium 113 separately, may proceed with the cathode 105 to step 116 for further cleaning, or may be destroyed as non-hazardous waste.

At step 116 the cathode 105 and anode 110, and, optionally, the removed separator 103 are washed using an organic solvent 118, for example, dimethyl carbonate (DMC), dimethyl ether (DME), or other solvents that can dissolve the electrolyte 107 for recycling. In one example, the electrodes are fully submerged, partially submerged, or otherwise washed, in DMC under an inert gas atmosphere, such as nitrogen, or under temperature below standard room temperature (to prevent the electrolyte from catching fire) for between about 30 minutes and about one hour (inclusive) with optional agitation. The cathode 105 is typically a film formed of the lithium base electrode material, e.g. LiCoO₂, mixed with carbon and a binder, e.g., Polyvinylidene fluoride (PVDF), on a cathode current collector 106, for example aluminum for a LiCoO₂ based cathode. In an end of life battery, the lithium base electrode material has been depleated of Lithium and will therefore be annotated as LiₓCoO₂ where x is less than 1 (x<1). The anode 110 is typically a film formed of graphite mixed with a binder, e.g., PVDF, on an anode current collector 112, for example aluminum. The process 100 is equally applicable to other anode type, including, for example, silicon anodes. At step 120, the cathode 105 and optionally the anode 110 are submerged, and optionally agitated, e.g. sonicated or stirred, in a solvent 122, e.g., N-Methyl-2-pyrrolidone (NMP) or any other solvent that can dissolve the binder). If both the cathode 105 and anode 110 are submerged in solvent, they may be submerged in different vessels. The electrodes 105, 110, in one example are agitated at about 1000 rpm of a respective sonicator or stirrer for between about 15 minutes and about one hour (inclusive) at a temperature of between about 40° C. and about 60° C. (inclusive). The solvent 122 dissolves the respective binders. In the case of the anode 110, the remaining anode current collector, e.g., copper film, may be removed and recycled to the input materials for new battery manufacture. In the case of the cathode 105, at step 130, the cathode current collector 106 is removed from the suspension 132 of solvent 122, binder material, LiₓCoO₂ and graphite. Then the cathode current collector 106 (typically aluminum film) is recycled to the input materials for new battery manufacture, for example, by shredding.

After removing the cathode current collector 106 from solvent 122, the remaining black suspension 132 is composed of binder in, for example, NMP solvent 122, carbon additives from the cathode film, and the cycled active cathode materials (e.g., LiₓCoO₂). At step 140 the suspension 130 is passed through a filter media 142 which retains the LiₓCoO₂ and passes the solvent 122 and remaining cathode elements, leaving the combination 144 for further recycling or waste processing. Carbon from the cathode, typically about 1 weight (wt) percent is typically filtered as well and will be burned away during further heat treatment discussed below. The filter medium, in one example has between about 1 micron and 10 micron (inclusive) pore sizes. The suspension is filtered in order to separate the carbon/cycled cathode materials and the NMP solution with binder dissolved. As an alternative to filtering, the suspension 132 may also be centrifuged at, for example about 1600 rpm for about 20 min. If centrifuged, the top liquid layer can be removed and discarded. This centrifuge washing process (with solvent 122) may be performed more than once, for example twice, remove the cathode binder. Step 150 shows the removal of the filtered (or centrifuged), but still wet, depleted lithium cathode material (e.g., LiₓCoO₂) 152.

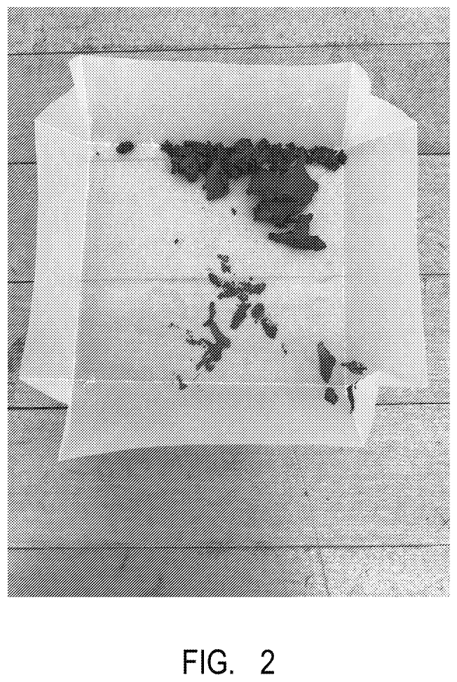

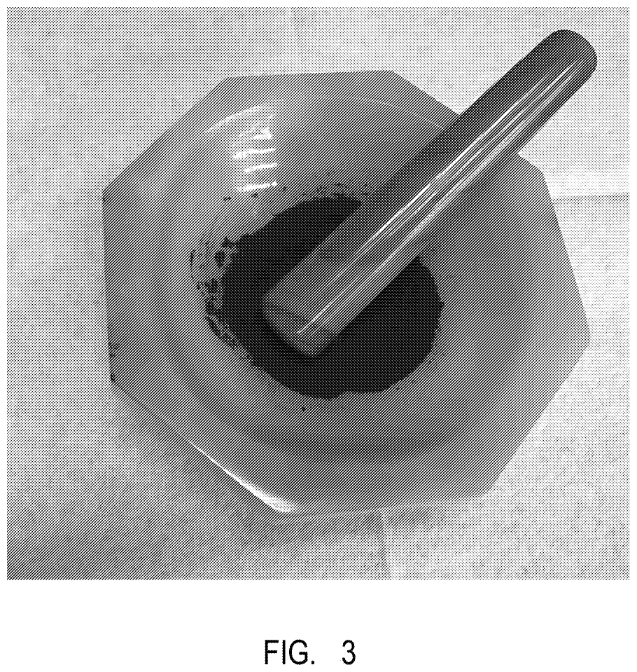

At step 160 the wetted depleted lithium cathode material 152 is dried, for example in an oven 160, hot air conveyer, or any other temperature controlled environment. The depleted lithium cathode material 152 should be dried until the weight no longer significantly changes. For example, for about eight hours at about 100° C. FIG. 2 shows a photograph of dried depleted lithium cathode material LiₓCoO₂152. At step 170 (FIG. 1), dried depleted lithium cathode material is ground (see FIG. 3) to obtain a uniform homogeneous powder shown as depleted lithium cathode material powder 182 at step 180. While FIG. 3 shows a mortar and pistil, any other method of grinding or for created uniform particle size may be used.

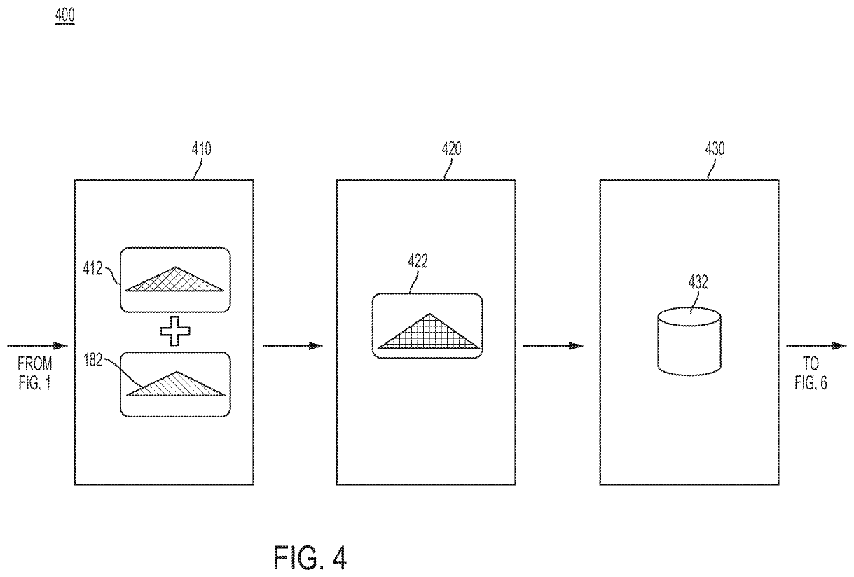

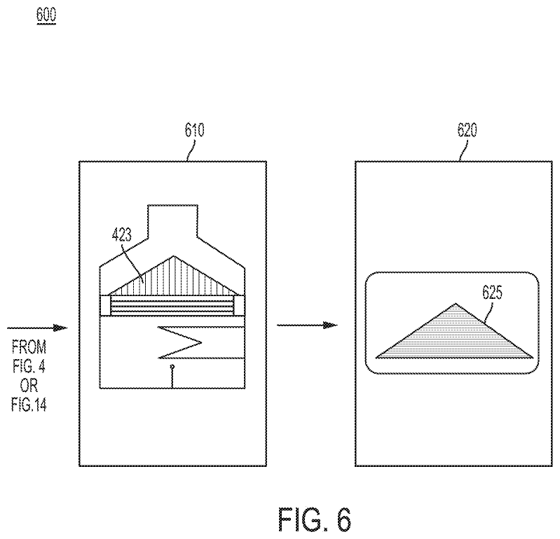

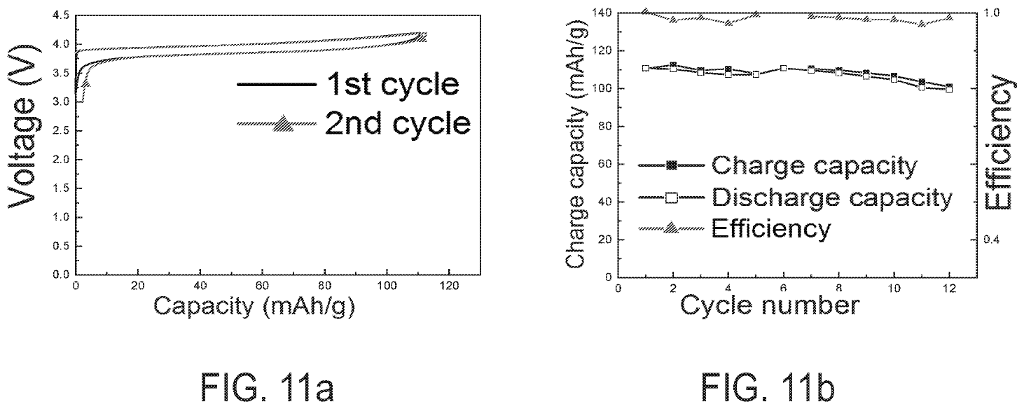

The depleted lithium cathode material powder 182 may then be utilized in two re-lithiation processes, which are alternative to each other. The first being discussed with references to FIGS. 4-6, the second with respect to FIGS. 11 and 6.

With reference to FIG. 4, the first re-lithiation process 400 will be discussed. This examples continues to use the LiCoO₂ electrode technology as an example. However, as noted earlier, the process 400 is equally applicable to other lithium based battery technologies.

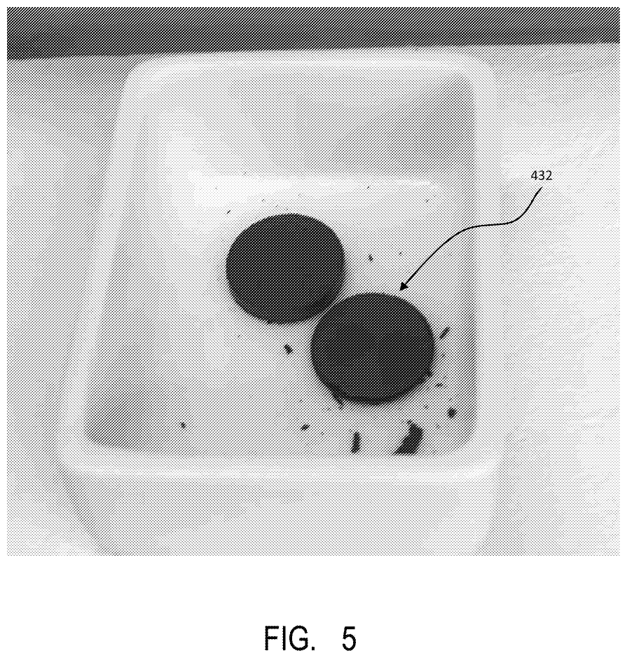

At step 410 an amount of a lithium containing material powder 412, for example LiOH.H₂O, having similar physical particle size as depleted lithium cathode material powder 182 is obtained. Other lithium containing materials, for example Li₂CO₃, LiCH₃COO, may also be used. However only LiOH.H₂O will be discussed further in this example for simplicity. At step 420, the depleted lithium cathode material powder 182(LiₓCoO₂) is homogenously mixed with the lithium containing material powder 412. The mixture is in a stoichiometric ratio of 1 mol LiₓCoO₂ to (1−x) mol of LiOH.H₂O. Typically, LixCoO₂ from a fully cycled (end of life) cathode would have an x value of about 0.5. Therefore, in one test example, the mass ratio of 1LixCoO₂to (1−x) LiOH.H₂O is about 298.6 milligrams (mg) to 177.46 mg. However, if x is not believed to about 0.5 (e.g., the battery has not been fully cycled), x may be determined by elemental analytical techniques,for example, inductively coupled plasma atomic emission spectroscopy (ICP-AES), or similar, and the molar amount of (1−x) mol of LiOH.H₂O be adjusted accordingly. The resulting homogeneous mixture 422 is pressed at step 430 into a cylindrical pellet 432 form or other compact form, which provides for uniform processing. A photograph of two example pellets 432 is shown in FIG. 5.

With reference to FIG. 6, the cylindrical pellet(s) 432 are heated at step 610. The heating takes place in air at between about 100-700° C. for between 1-6 hours (inclusive). The heating helps drive the reaction of equation (EQN) 1 below, and also proceeds to recrystallize LiCoO₂.

4LiₓCoO₂+4(1−x)LiOH.H₂O>4LiₓCoO₂+6(1−x)H₂O+(1−x)O₂ (EQN 1):

While the reaction of EQN 1 can proceed at up to 700° C., there are particular advantages to maintaining the temperature at or below 500° C. For example, heating between about 100-500° C. (inclusive), which is below the sintering temperature. Heating above 500° C., not only wastes energy, but can cause decomposition of residual organics within the material and carbon deposits. The decomposition forms gas that can prevent cracks within the LiCoO₂ crystals from healing during the heating, which ultimately makes the LiCoO₂ particles smaller. That is, the particle morphology of the LiCoO₂ particles is different than that used to form new batteries. As noted above, hearting between about 100-500° C. (inclusive) for between 1-6 hours sufficiently aides the re-lithiation process, while also avoiding the negative effects of sintering (at higher temperatures). In one particular example, the heating takes place at around 300° C. It may be advantageous in certain condition, to add an additional 3-5% extra LiOH.H₂O at step 410 to compensate for the lithium loss during high temperature heating. At step 620 he resulting re-lithiated cathode material 625 is removed from the oven 610 and is ready to be reused as a raw material for cathode manufacturing.

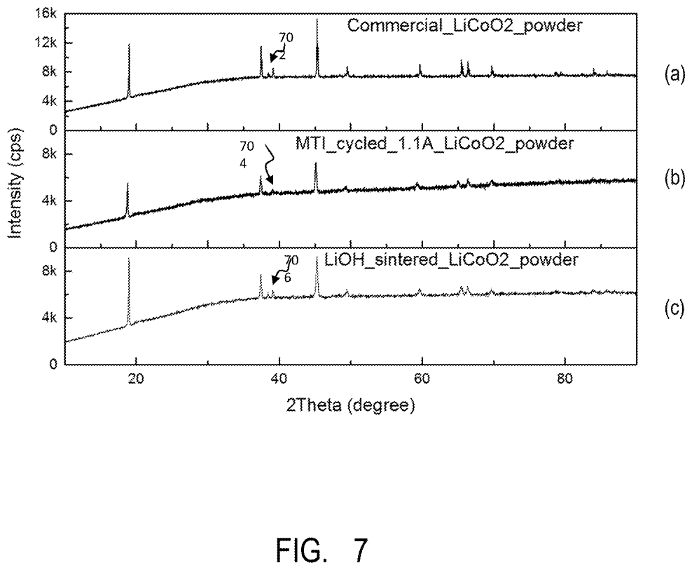

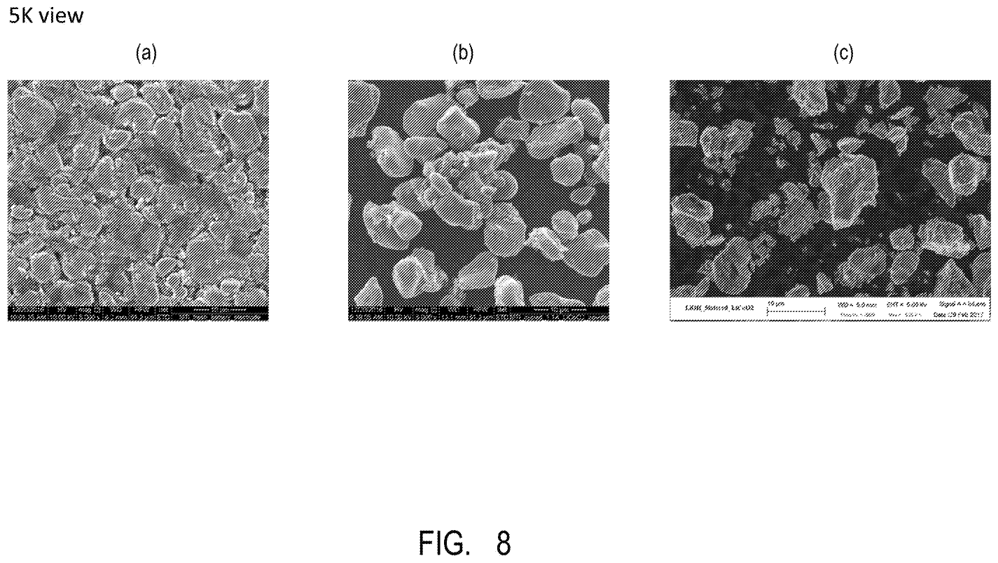

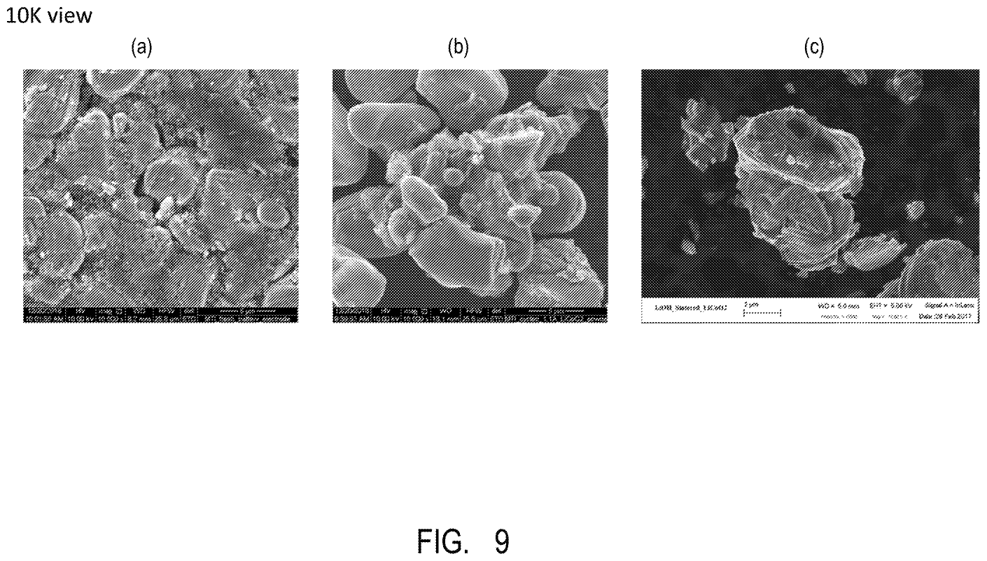

FIG. 7 shows X-ray diffraction (XRD) patterns of commercially available LiCoO₂ (a) (prior to incorporation in a battery and cycled), LixCoO₂ (b)(cycled LiCoO₂) and recycled LiCoO₂ (c) using the processes 100, 400, and 600. The diffraction peak 702 around 38 degrees on graph (a) disappears at 704 for the LixCoO₂ sample (b) due to lithium extraction during battery cycling. The peak 706 shows up again for the recycled LiCoO₂ using the processes 100, 400, and 600. This indicates that the recycled LiCoO₂ has the same crystal structure (morphology) as the commercially available LiCoO₂ and commercially available virgin (or uncycled) LiCoO₂ electrode. FIGS. 8-9 shows scanning electron microscope (SEM) views at 5,000 times magnification (×5K) and 10,000 times magnification (10K) magnification, respectively, of the morphologies of an example MTI Corporation (Richmond, Calif.) battery having a new LiCoO₂ electrode (a), LixCoO₂ (b)(cycled LiCoO₂), and recycled LiCoO₂ (c) using the processes 100, 400, and 600. The recycled LiCoO₂ (c) shows that it retains the same morphology and particle size distribution of the MTI battery fresh LiCoO₂ electrode (a).

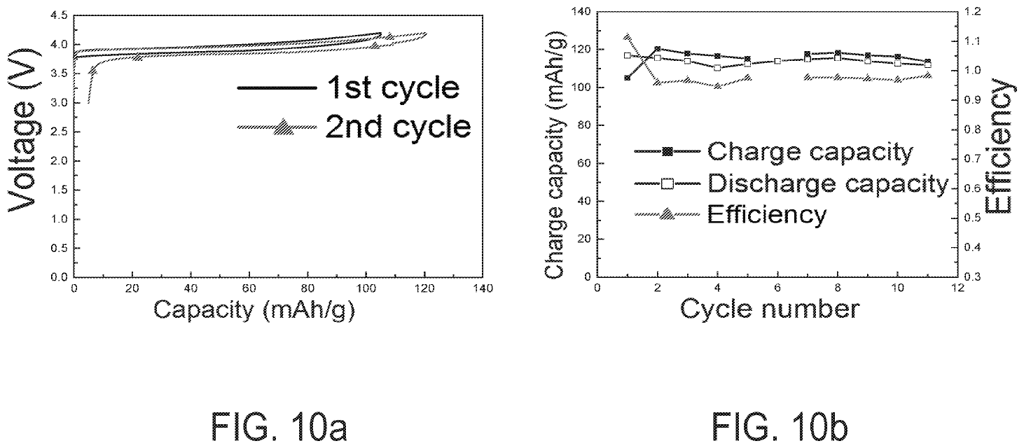

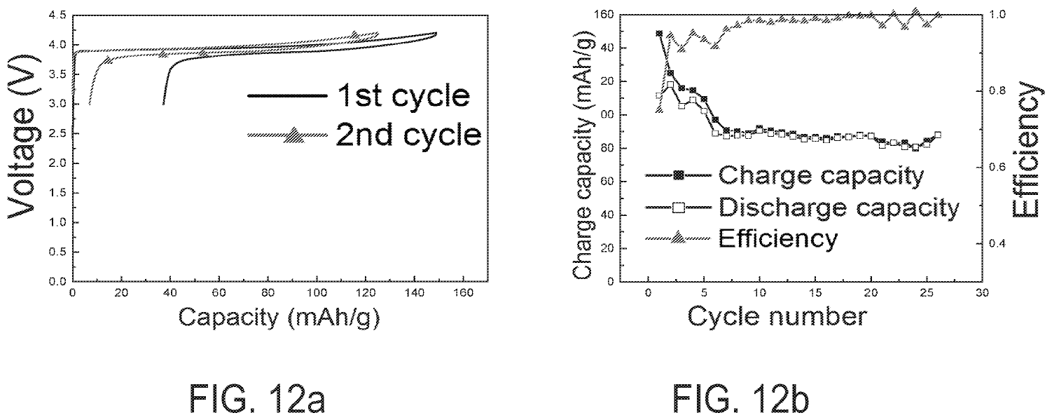

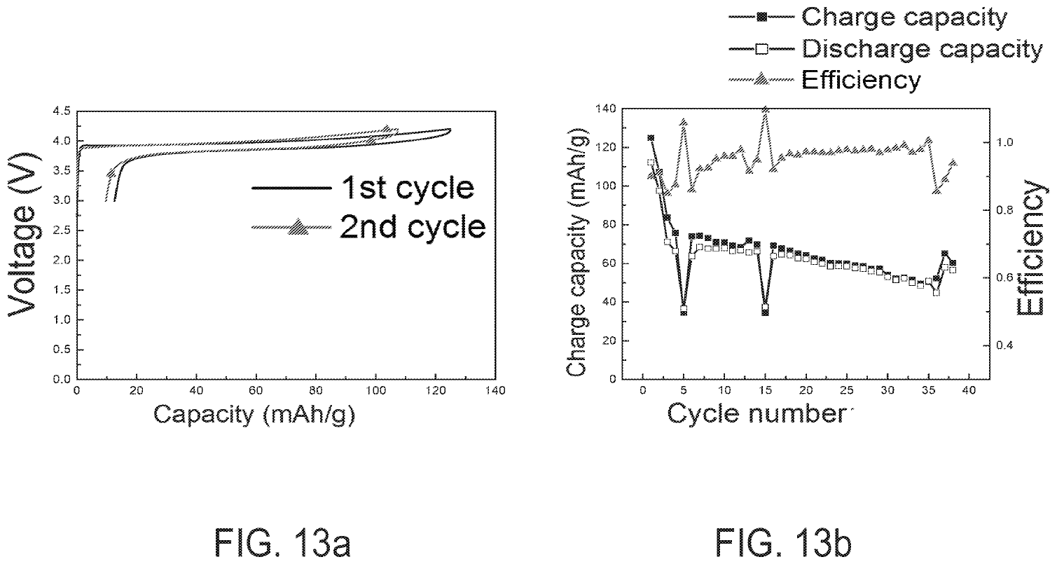

FIGS. 10a-13b show the electrochemical performance of four example Li-ion cells using recycled LiCoO₂ electrode material at the C/20 (FIGS. 10-11) and C/10 (FIGS. 12-13) rates, respectively. The example cell tested in FIGS. 10a and 10b utilizes 21.52 mg of active recycled cathode material (LiCoO₂) and resulted in first two cycle capacities of 105.06 mAh/g and 120.47 mAh/g each at a cycling test rate of C/20. The example cell tested in FIGS. 11a and 11b utilizes 27.6 mg of active recycled cathode material (LiCoO₂) and resulted in first two cycle capacities of 110.52 mAh/g and 112.54 mAh/g each at a cycling test rate of C/20. The example cell tested in FIGS. 12a and 12b utilizes 7.52 mg of active recycled cathode material (LiCoO₂) and resulted in first two cycle capacities of 148.87 mAh/g and 125.02 mAh/g each at C/10 and a cycling test rate of C/10. The example cell tested in FIGS. 13a and 13b utilizes 10.16 mg of active recycled cathode material (LiCoO₂) and resulted in first two cycle capacities of 124.88 mAh/g and 107.289 mAh/g each at C/10 and a cycling test rate of C/10. The delivered capacity of each of the example test cells shown in FIGS. 10a-13b is within normal deviation to the commonly reported value for comparable amounts of active cathode material, which indicates successful direct recycling of the cathode materials.

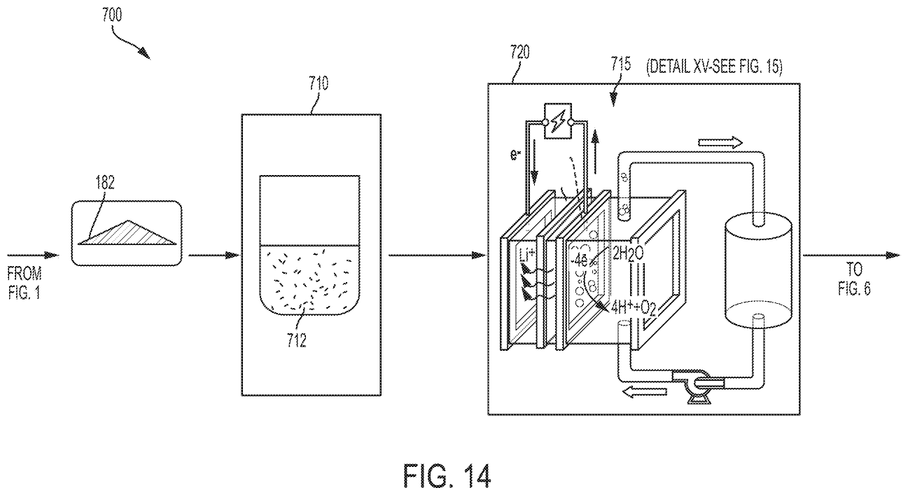

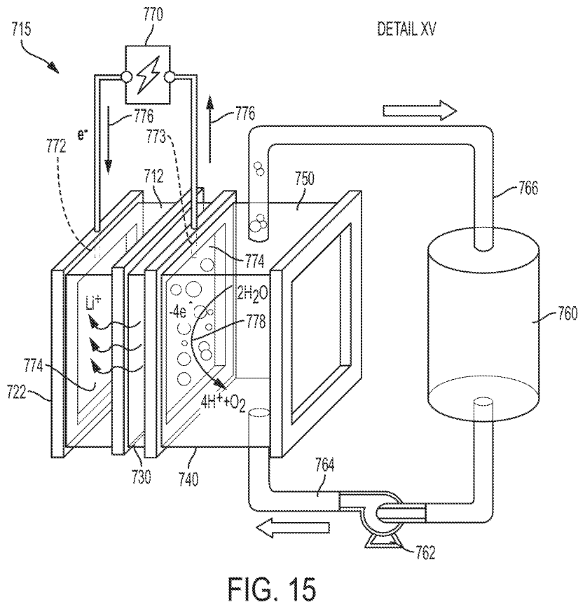

With reference to FIG. 14-15, the second alternative re-lithiation process 700 will now be discussed. Process 700 begins with the depleted lithium cathode material powder 182 obtained through process 100 (FIG. 1). At step 710, the depleted lithium cathode material powder 182 (e.g. LiₓCoO₂) is placed into a cathode suspension 712 containing at least one lithium salt. Examples include, but are not limited to lithium sulfate, lithium nitrate, and lithium chloride suspended as an aqueous suspension or, in the alternative, another solvent such as organic solvents including, but not limited to DMC and ethylene carbonate (EC). The concentration of the cathode suspension 712 may range from seawater lithium concentration of about 100 micrograms (μg) per liter (L) to about 1 mol/L of an artificial or “pure” solution, meaning only lithium based salts are in the solution. As will be discussed below, process 700 may utilize all lithium ion containing solutions. The depleted lithium cathode material powder 182 should be combined with the lithium salt suspension in a one to one ratio by volume. At step 720 the LixCoO₂ within the LixCoO₂/lithium salt suspension 712 is re-lithiated within a re-lithiation electrochemical flow system 715, which will be discussed in greater detail with reference to detail XV shown in FIG. 15.

The re-lithiation electrochemical flow system 715 includes a galvanic cell, which includes a cathode chamber 722, an anode chamber 740, and a galvanic separator 730. The cathode and anode chambers 722, 740 may be made of any non-reactive material including, without limitation, stainless steel, glass, or polymer. Each of the cathode and anode chambers 722, 740 have an opening which interfaces to the galvanic separator 730. A seal, for example, rubber, silicone, or other resilient material, may be optionally used between the edges of each chamber 722,740 and the galvanic separator 730 to prevent leaks.

A working electrode 772 is inserted into cathode chamber 722. The working electrode may be, for example formed of nickel mesh or carbon plate. A counter electrode 773, for example, formed of platinum (Pt) mesh is inserted into the anode chamber 740. An additional reference electrode (not shown), for example, formed of Ag/AgCl, is inserted into either the cathode chamber 722 or the anode chamber 740 in the same way as either the working electrode 772 or counter electrode 773. Connected to each of the working electrode 772 and counter electrode 773 through conductors is a constant current power supply 770. It should be noted that while we refer to the working electrode 772 as an “electrode,” the working electrode may function more like a current collector while the depleted lithium cathode material powder 182 (e.g. LixCoO₂ or other active cathode materials) function as the reactant.

The anode chamber 740 is supplied from, and is hydraulically connected to, lithium reservoir 760 through a pressure source 762 and a feed pipe 764. Lithium reservoir 760, in one example, has a greater volume than anode chamber 740. Lithium reservoir 760, in one example, has a total charge storage capacity that is at least 5 times larger than the charge storage capacity of the anode chamber 740.

Liquid is returned to the lithium reservoir 760 through a return pipe 766. It should be noted that the configuration shown shows a centrifugal pump representation as a pressure source 762 in the feed pipe. However, other effective methods of creating fluid flow are also acceptable. For example, the lithium reservoir 760 could gravity feed the anode chamber 740 and pressure source 762 could be in the return pipe 766. In addition, other types of pumps may be used.

As noted above, the anode chamber lithium salt containing solution may be the same lithium salt containing solution used to make suspension 712 or a different solution. This provides the ability to shortcut the lithium refining process and further decrease the cost of restoring the depleted lithium. For example, the anode chamber lithium salt containing solution may be a “pure” solution, meaning only lithium based salts are in the solution. However, in an alternative, the reservoir 760 may be an “un-pure” brine pool containing non-lithium based salts and the anode chamber lithium salt containing solution may be the brine in a brine pool containing, for example, one to two weight percent of lithium and any number of other constituent elements. In yet another alternative, reservoir 760 may be the ocean, or a seawater containing vessel, and the anode chamber lithium salt containing solution may be seawater containing about 183 micrograms (μg) per liter (L). In yet another alternative, reservoir 760 may contain a lithium containing wastewater. And in yet another alternative, reservoir 760 may contain any number of lithium containing ores, for example spodumene, amblygonite, lepidolite, or eucryptite and a alkali-metal hydroxide (for example, KOH) solution can flow over or through the ore resulting in lithium-ion containing solution due to hydroxide solution leaching effect.

In yet another example, the lithium reservoir could be a source of naturally occurring water that flows during operation of the re-lithiation electrochemical flow system, to re-supply depleted lithium from continued use. For example, the flowing may be caused by pumping the naturally occurring water during operation of the re-lithiation electrochemical flow system. In another example, the flowing occurs due to naturally occurring events, which may include, but are not limited to rainfall, stream or river currents, underwater springs, tidal flow or wave action. And in yet another example, a tidal flow or wave action can be used to fill the lithium reservoir that subsequently, under the force of gravity, flows the anode chamber lithium salt containing solution to the anode chamber. Regardless of the lithium source, the flow of lithium from the reservoir, whether it be a stream, seawater, lithium ore, or a pure lithium salt, replenishes lithium in the anode chamber lithium salt containing solution, to the anode (positive) electrode, and ultimately to the re-lithiation reaction during operation.

The galvanic separator 730 may be any galvanic separator that effectively allows lithium ions to pass through it, for example ceramic and porous polymer separators. A polymer separator may be used if the lithium salt containing solution is a pure lithium based salt solution because the porous polymer separator could allow only non-lithium ions to pass through it. A ceramic separator may be use for pure lithium salt based solutions as well as non-pure solutions, e.g., seawater, seawater brine, and/or lithium ore based solutions. Example suitable polymer separators include, but are not limited to a fiber paper (for example, Cellulose based), or a trilayer polypropylene-polyethylene-polypropylene membrane having a pore size of about 0.21×0.05 μm and a porosity of about 39%, like that sold by MTI Corporation under the tradename Celgard (accessible at https://www.mtixtl.com/separatorfilm-EQ-bsf-0025-60C.aspx). Example suitable ceramic separators include, but are not limited to Li_{1+x+y}Al_{z}(Ti, Ge)_{2-z}Si_{y}P_{3-y}O₁₂, (Liₓ, La_{y})TiO_{z}, and (Liₓ, La_{y})ZrO_{z}.

In operation, the cathode chamber 722 is filled with the LiₓCoO₂ containing placed aqueous suspension 712. The anode chamber 740 is filled with a lithium salt containing solution which can be in static or flowing condition. It should be noted that a static condition solution would not require a reservoir 760, pressure source 762 or flow and return pipes 764, 766. The anode chamber lithium salt containing solution may be the same lithium salt containing solution used to make suspension 712 or a different solution.

Then, anodic current is applied to anode chamber 740, i.e., the constant current power supplies potential such that electrons flow in the directions of arrows 776 at about 10 mA of current. As the electrolyte (lithium salt containing solution) in the anode chamber 740 is going through an oxygen evolution reaction (OER) 778, the LixCoO₂ in the left chamber is reduced and lithium-ions 774 intercalates into the LixCoO₂ to form LiCoO₂. The theoretical mechanism of the reactions are shown in equations 2-4 below. However, it should be noted that the invention should not bound by the proposed theory of equations 2-4, they are merely discussed to assist a person of ordinary skill in the art of a representative general mechanism.

LiₓCoO₂+(1−x)Li⁺+(1−x)e⁻→LiCoO₂ EQN 2:

2H₂O→O₂+4H⁺+4e⁻ EQN 3:

LiCoO₂→LixCoO₂+(1−x)Li⁺+(1−x)e⁻ EQN 4:

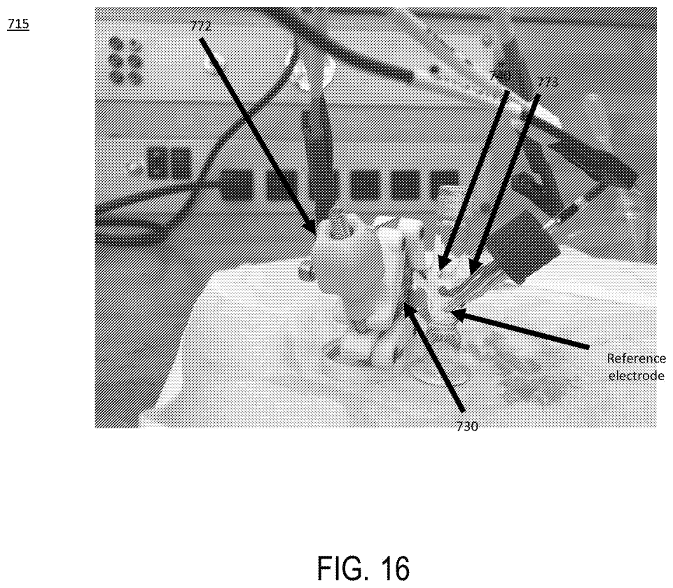

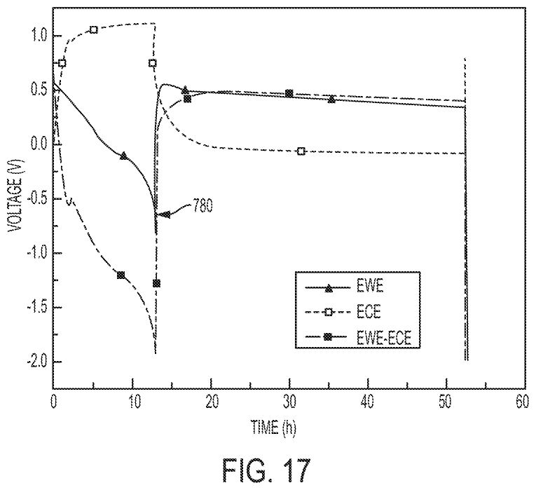

The potential of each of the working electrode 772 and counter electrode 773 are measured with respect to the reference electrode until the working electrode 772 potential versus the reference electrode potential reaches about −0.8V to about −1.0 V vs. Ag/AgCl. For most lithium-ion battery cathode materials, discharge to −0.8V to 1 V vs. Ag/AgCl will fully restore the lithium content. FIG. 16 shows a photograph of a portion of an example test re-lithiation electrochemical flow system 715. FIG. 17 shows an example plot of voltage versus time of an example working electrode 772 (EWE) (as compared to the reference electrode), counter electrode 773 (ECE) (as compared to the reference electrode), and the difference between the working electrode and the counter electrode (EWE-ECE). An example stopping point for the reaction is indicated at 780. If the reaction is stopped before reaching the target, then x in LixCoO₂ will remain less than 1, albeit greater than when fully cycled. If the reaction is not stopped at the stopping point, but continues undesirable reactions may proceed. For example, assuming a LiCoO₂ active cathode material, the reaction may may begin generating hydrogen gas instead of lithium intercalation reaction.

On advantage to utilizing the re-lithiation electrochemical flow system 715 as described is that the amount of lithium-ion intercalation can be precisely controlled by the cut-off potential, for example at stopping point 780. Other re-lithiation approaches require quantification of the amount of Lithium depletion (the x in LixCoO₂) before determining the optimal amount of lithium containing material to add. The re-lithiation electrochemical flow system 715, through process 100, 700, and 600 (as further exaplined below) can fully convert x to 1 by controlling the cutoff voltage of the electrochemical re-lithiation process without quantifying the x.

After this reaction, LixCoO₂ has been re-lithiated to become LiCoO₂. The re-lithiated LiCoO₂ is removed from the cathode chamber 722 for use. The LiCoO₂, in one example may be further washed with solvent, such as NMP, and dried before use. In addition, the morphology of the re-lithiated LiCoO₂ may be improved if subjected to the heating process 600 discussed above with reference to FIG. 6.

Following the heating process 600, the re-lithiated LiCoO₂ has the same crystal structure as the commercially available LiCoO₂.

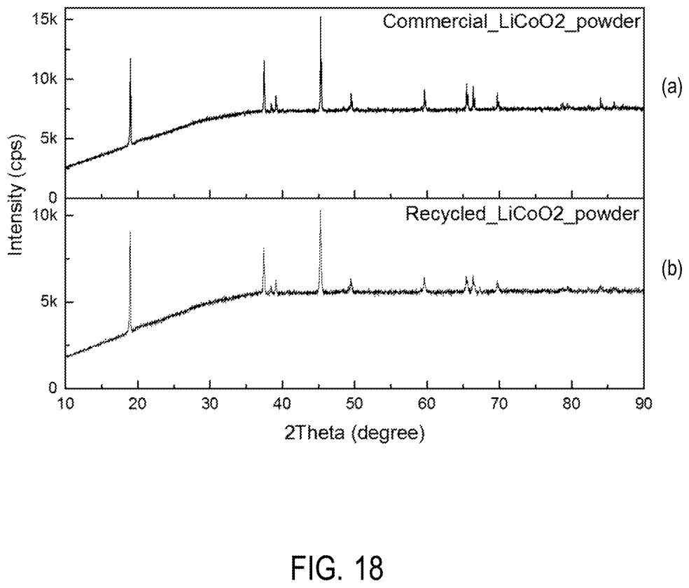

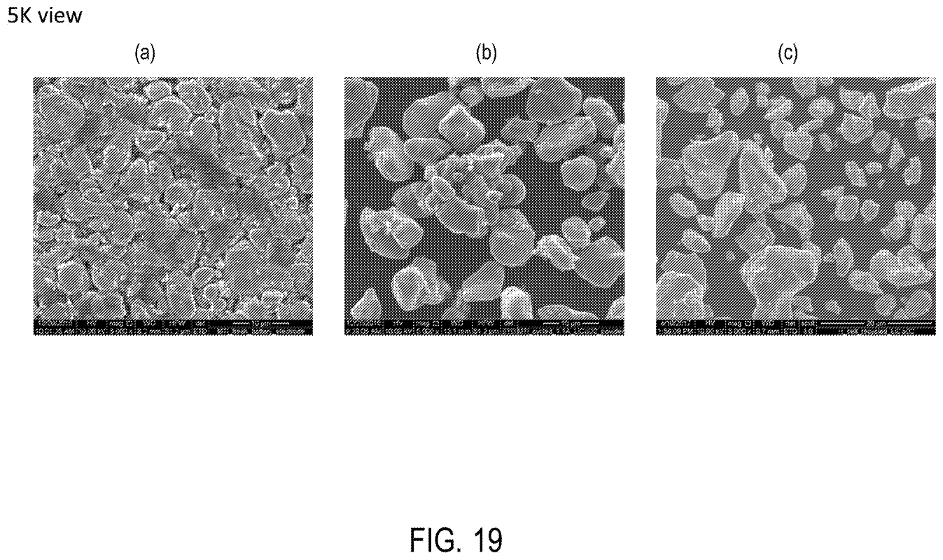

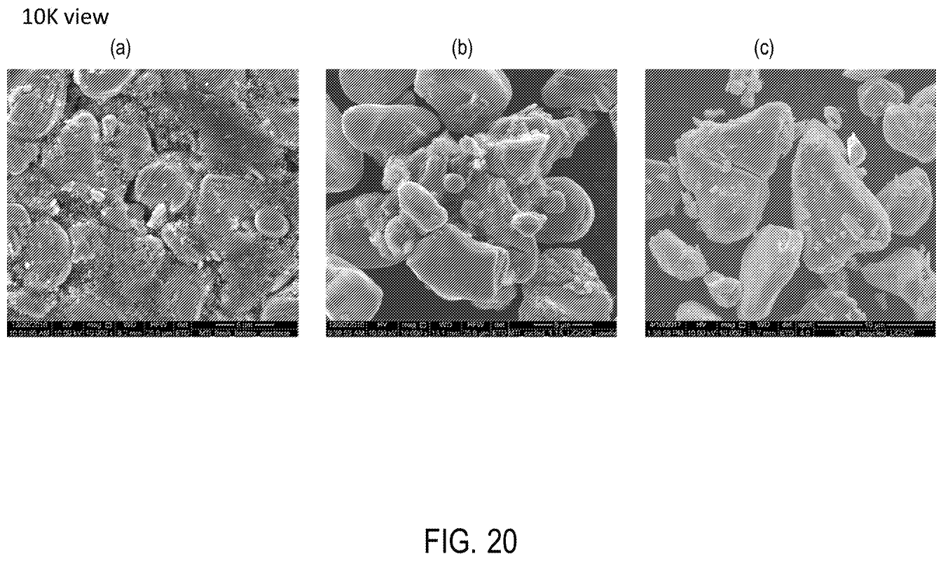

FIG. 18 shows X-ray diffraction (XRD) patterns of commercially available LiCoO₂ (a) (prior to incorporation in a battery and cycled), and recycled LiCoO₂ (b) using the processes 100, 400, and 600. The diffraction peak 702 around 38 degrees on graph (a) disappears 704 for the LixCoO₂ sample (b) due to lithium extraction during battery cycling. The peak 706 shows up again for the recycled LiCoO₂ using the processes 100, 700, and 600. This indicates that the recycled LiCoO₂ has the same crystal structure (morphology) as the commercially available LiCoO₂ and commercially available virgin LiCoO₂ electrode. FIGS. 19-20 shows scanning electron microscope (SEM) views at ×5K and ×10K magnification, respectively, of the morphologies of an example MTI Corporation (Richmond, Calif.) battery having a new LiCoO₂ electrode (a), LiₓCoO₂ (b)(cycled LiCoO₂), and recycled LiCoO₂ (c) using the processes 100, 700, and 600. The recycled LiCoO₂ (c) shows that it retains the same morphology and particle size distribution of the MTI battery fresh LiCoO₂ electrode (a).

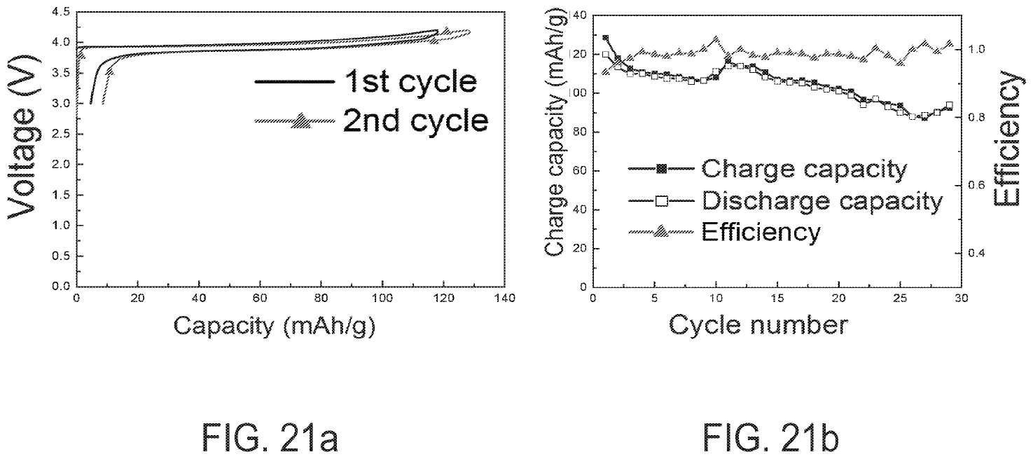

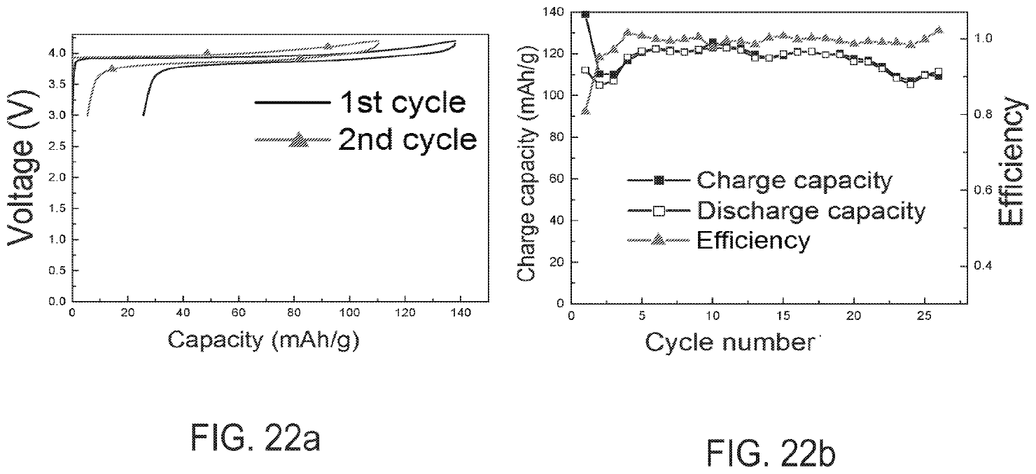

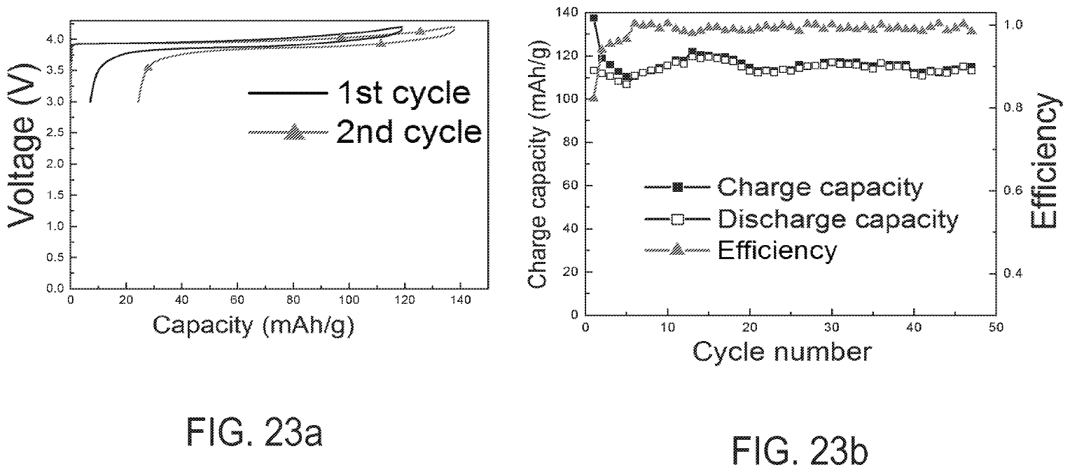

FIGS. 21a-23b show the electrochemical performance of three example Li-ion cells using recycled LiCoO₂ electrode material at the C/20 (FIGS. 21-22) and C/10 (FIG. 23) rates, respectively. The example cell tested in FIGS. 21a and 21b utilizes 16.16 mg of active recycled cathode material (LiCoO₂) and resulted in first two cycle capacities of 128.61 mAh/g and 118.06 mAh/g each at a cycling test rate of C/20. The example cell tested in FIGS. 22a and 22b utilizes 14.32 mg of active recycled cathode material (LiCoO₂) and resulted in first two cycle capacities of 137.92 mAh/g and 110.33 mAh/g each at a cycling test rate of C/20. The example cell tested in FIGS. 23a and 23b utilizes 11.52 mg of active recycled cathode material (LiCoO₂) and resulted in first two cycle capacities of 137.62 mAh/g and 118.98 mAh/g each at C/10 and a cycling test rate of C/10. The delivered capacity of each of the example test cells shown in FIGS. 21a-23b is within normal deviation to the commonly reported value for comparable amounts of active cathode material, which indicates successful direct recycling of the cathode materials.

As an alternative, the end of life cathode film itself (include current collect) may serve as the working electrode within re-lithiation electrochemical flow system 715 (FIG. 15.). In such an alternative, the cathode 105 (FIG. 1) may be removed from the electrolyte solvent 118, optionally shredded, and placed directly in cathode chamber 722 as the working electrode within with aqueous suspension containing at least one lithium salt 712. The re-lithiation electrochemical flow process 700 would then proceed as discussed above. Following the completion of process 700, the cathode 700 would proceed to step 120 (FIG. 1) and the remainder of processes 100 and 400 would be carried out (with the exception of adding lithium containing material 412).

The above description and drawings are only to be considered illustrative of specific embodiments, which achieve the features and advantages described herein. Modifications and substitutions for specific conditions and materials and otherwise can be made. Accordingly, the inventions are not considered as being limited by the foregoing description and drawings, but are intended to embrace all such alternatives, modifications, substitutes and variances.

What is claimed as new and desired to be protected by Letters Patent is:

1. A method of re-lithiating a lithium depleted cathode active material, the method comprising the steps of:
adding lithium containing material to the depleted cathode active material to form a combination; and
heating the combination to greater than or equal to about 100 degrees Celsius and to less than a sintering temperature of the combination for a time period of greater than or equal to one hour.

2. The method of claim 1, wherein the lithium depleted cathode active material is at least one of lithium depleted LiCoO₂, lithium depleted LiNiₓMn_{y}CozO₂ (x+y+z=1), lithium depleted LiMn_{y}O₄, and lithium depleted LiFePO₄.

3. The method of claim 1, wherein the combination is heated to no more than about 500 degrees Celsius.

4. The method of claim 2, wherein the method further comprises:
separating the depleted cathode active material from a cathode.

5. The method of claim 4, wherein separating the lithium depleted cathode active material from the cathode includes dissolving a cathode binder in a solvent and suspending the lithium depleted cathode active material in the solvent.

6. The method of claim 5, wherein separating the lithium depleted cathode active material from the cathode includes separating the lithium depleted cathode active material from the solvent by a filter and/or a centrifuge.

7. The method of claim 6, wherein separating the lithium depleted cathode active material from the cathode includes at least one of drying and grinding the lithium depleted cathode active material prior to adding the adding lithium containing material.

8. The method of claim 4, wherein separating the lithium depleted cathode active material from the cathode includes rinsing the cathode in dimethyl carbonate.

9. The method of claim 1, wherein adding lithium containing material to the lithium depleted cathode active material includes adding the lithium depleted cathode active material to a suspension containing at least one lithium salt, wherein the lithium depleted cathode active material and the suspension are within a cathode chamber.

10. The method of claim 9, wherein the cathode chamber is adjacent an anode chamber containing an anode chamber lithium salt containing solution, wherein a galvanic separator is between the cathode chamber and the anode chamber, and wherein the galvanic separator is adapted to pass lithium ions.

11. The method of claim 10, wherein adding lithium containing material to the lithium depleted cathode further comprises supplying a constant current voltage potential to a working electrode electrically connected to the lithium depleted cathode active material and to a counter electrode electrically connected to the anode chamber lithium salt containing solution.

12. The method of claim 10, wherein adding lithium containing material to the lithium depleted cathode further comprises supplying a constant current voltage potential to a working electrode electrically connected to the lithium depleted cathode active material and to a counter electrode electrically connected to the anode chamber lithium salt containing solution.

13. The method of claim 12, wherein the working electrode has a positive voltage potential as compared to the counter electrode.

14. The method of claim 12, wherein the counter electrode and the lithium salt containing solution undergo an oxygen evolution reaction.

15. The method of claim 12, further comprising stopping the constant current voltage potential when the working electrode potential versus a reference electrode potential reaches between about −0.8V to about −1.0 V, inclusive.

16. The method of claim 12, wherein the heating the combination step takes place after supplying a constant current voltage potential.

17. The method of claim 10, wherein the anode chamber is hydraulically connected to a lithium reservoir via a feed pipe.

18. The method of claim 17, wherein the lithium reservoir has a greater volume than the anode chamber.

19. The method of claim 18, wherein the lithium reservoir contains at least one of lithium containing seawater, brine water, wastewater, and lithium containing ores.

20. The method of claim 17, wherein the lithium reservoir has a total charge storage capacity that is at least five times larger than the charge storage capacity of the anode chamber.

21. The method of claim 1, wherein separating the depleted cathode active material from the cathode includes at least one of drying and grinding the depleted cathode active material prior to adding the lithium containing material.

22. The method of claim 1, wherein the heating step makes a re-lithiated cathode active material and the re-lithiated cathode active material comprises an x-ray diffraction peak at about 38 degrees.

23. A re-lithiation electrochemical flow system, the flow system comprising:
a cathode chamber containing a cathode electrode and a suspension containing at least one lithium salt and a lithium depleted cathode active material;
an anode chamber containing an anode electrode and an anode chamber lithium salt containing solution;
a galvanic separator between the cathode chamber and the anode chamber, wherein the galvanic separator is adapted to pass lithium ions; and
a lithium reservoir having a total charge storage capacity that is at least five times larger than a charge storage capacity of the anode chamber lithium salt containing solution within the anode chamber.
